(19) United States
(12) Patent Application Publication
(10) Pub. No.: US 2013/0233132 A1
(43) Pub. Date: Sep. 12, 2013

(54) COMBINATION STRUCTURE OF HEAD PART AND GRIP COVER OF RATCHET WRENCH

(71) Applicant: Chia-Yu CHEN, Taichung City (TW)

(72) Inventor: Chia-Yu CHEN, Taichung City (TW)

(21) Appl. No.: 13/414,528

(22) Filed: Mar. 7, 2012

(51) Int. Cl. B25B 13/46

(52) U.S. Cl. 81/60

(57) ABSTRACT

A combination structure includes a head part and a grip cover. The head part includes a bottom end having a front side formed with a first stage portion, a rear side formed with a second stage portion, a left side formed with a third stage portion, a right side formed with a fourth stage portion, and a middle portion provided with a grip body. The grip cover includes a slot inserted by the grip body of the head part. At a top end of the grip cover, a first connecting portion, a second connecting portion, a third connecting portion and a fourth connecting portion are provided. The first, second, third and fourth connecting portions of the grip cover are respectively to the first, second, third and fourth stage portions of the head part. Accordingly, the head part and the grip cover are embedded to each other with increased fitness therebetween.

### BACKGROUND OF THE INVENTION

1. Field of the Invention

The present invention relates to a ratchet wrench.

2. Description of the Prior Art

Ratchet wrench is one of the most widely-used tools in our daily life for driving bolts or hats. Referring to FIG. 1, a longitudinal sectional view of a conventional ratchet wrench is illustrated. The conventional ratchet wrench integrally formed by a hard metal includes a head part 209 and a body part 210 provided with a core material 211. A light cladding layer 212 made of aluminum is utilized to enclose from the body part 210 to a sidewall edge of the head part 209. With the integrally-formed structure by the cladding layer 212, when using the conventional ratchet wrench to drive the bolt or nut by a user, the conventional ratchet wrench generally can sustain an abutting force acted on the head part 209 thereof, capable of effectively preventing the cladding layer located at the head part 209 from deformation and increasing the structural strength.

Due to the circumference of the head part 209 of the conventional ratchet wrench being integrally enclosed by the cladding layer, part of the cladding layer located at the distal end of the conventional ratchet wrench shall be formed with a handheld grip portion with a large outer diameter and a large thickness. However, the portion of the conventional ratchet wrench provided with large thickness is often formed with imperfections in the molding process. Further, the large volume portion of the conventional ratchet wrench provided often needs a longer formation time, and the productivity and the yield rate of the ratchet wrench are relatively decreased. Moreover, due to the cladding layer of the conventional ratchet wrench generally made of expensive, light material such as high molecular polymer, aluminum or magnesium alloy, the productivity competitiveness is lowered in the market and thus unsuitable for being applied in the ratchet wrenches. Improvement on these conventional ratchet wrenches is required.

### BRIEF SUMMARY OF THE INVENTION

In view of this, the purpose of the present invention is to provide a combination structure of a head part and a grip cover of a ratchet wrench, particularly to provide a combination structure of a head part and a grip cover of a ratchet wrench with a high combination fitness.

In order to attain the purpose above, the present invention provides a combination structure of a head part and a grip cover of a ratchet wrench. The combination structure includes a head part and a grip cover. The head part includes a bottom end having a front side formed with a first stage portion, a rear side formed with a second stage portion, a left side formed with a third stage portion, a right side formed with a fourth stage portion, and a middle portion provided with a grip body. The grip cover includes a top end and a slot formed on the top end and inserted by the grip body of the head part. At two sides of a top end of the grip cover, a first connecting portion, a second connecting portion, a third connecting portion and a fourth connecting portion are provided. The first, second, third and fourth connecting portions of the grip cover are respectively corresponding to the first, second, third and fourth stage portions of the head part.

In the combination structure of the head part and the grip cover of the ratchet wrench provided by the present invention, the first stage portion and the second stage portion of the head part are respectively and correspondingly embedded to the first connecting portion and the second connecting portion of the grip cover, so that the head part and the grip cover are correspondingly embedded and combined to each other and the fitness therebetween can be increased. Furthermore, due to the grip cover formed by injection molding in an independent mold and having easily-controlled molding conditions, it is therefore that the present invention has a low manufacturing cost and high productivity competitiveness in the market

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a longitudinal sectional view of a conventional ratchet wrench;

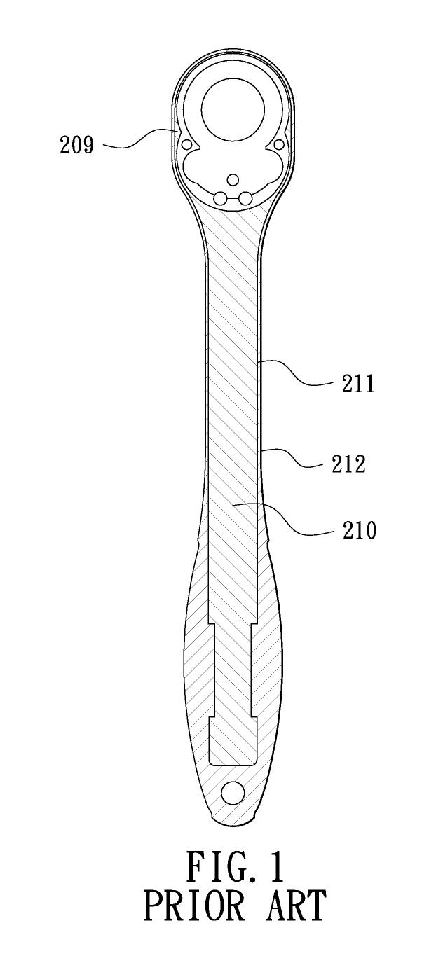

FIG. 2 is an exploded perspective view of a first preferred embodiment of the present invention;

FIG. 3 is a side view of a head part of the present invention;

FIG. 4 is a front view of a head part of the present invention;

FIG. 5 is a front view of a grip cover of the present invention;

FIG. 6 is an assembled perspective view of the first preferred embodiment of the present invention;

FIG. 7 is a front view of the first preferred embodiment of the present invention; and

FIG. 8 is a front view of a second preferred embodiment of the present invention.

### DETAILED DESCRIPTION OF THE INVENTION

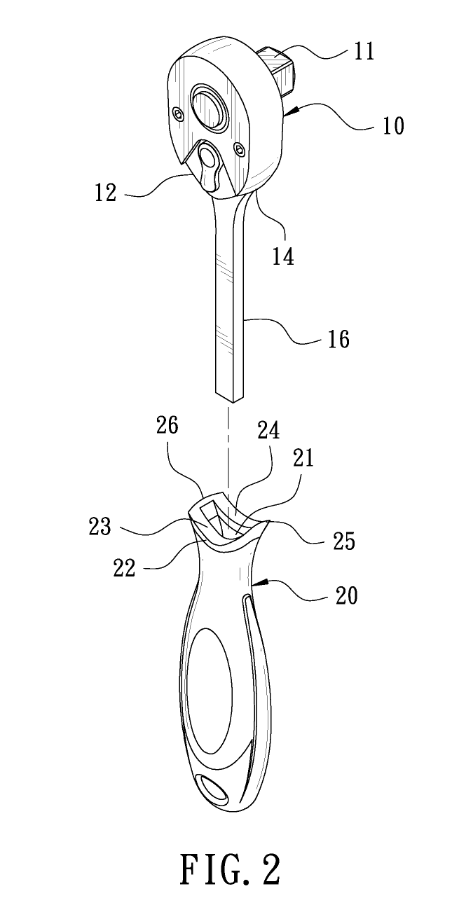

Referring to FIG. 2, an exploded perspective view of a combination structure of a head part and a grip cover of a ratchet wrench of a first preferred embodiment of the present invention is illustrated. The combination structure mainly comprises a head part 10 and a grip cover 20.

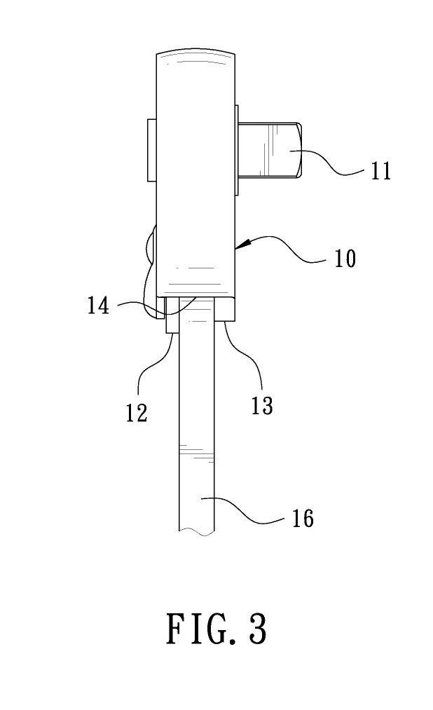

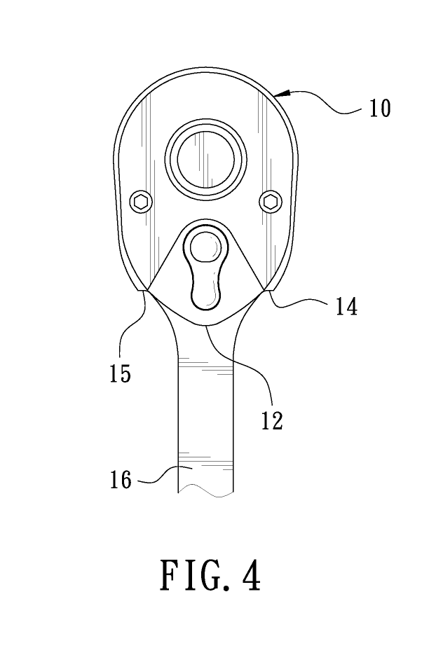

Referring to FIGS. 3 and 4, a side view and a front view of the head part 10 of the present invention are illustrated. The head part 10 made of a preferred rigid and hard metal is integrally formed and enclosed by a light material selected from one of high molecular polymer, aluminum or magnesium alloy. In this embodiment, the head part 10 is made of aluminum. A ratchet mechanism 11 is disposed at a rear side of the head part 10. The head part 10 comprises a bottom end which has a front side formed with a first stage portion 12, a rear side formed with a second stage portion 13, a left side formed with a third stage portion 14, a right side formed with a fourth stage portion 15, and a middle portion integrally extended with a grip body 16. In this embodiment, the first stage portion 12 and the second stage portion 13 of the head part 10 are respectively formed of concave arc surfaces.

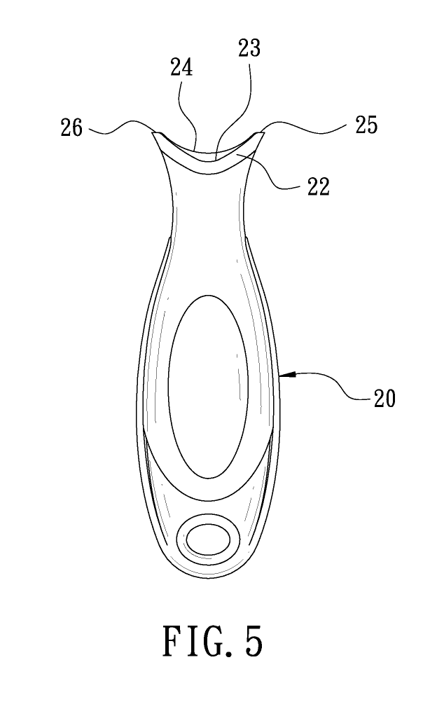

Referring to FIG. 5, a front view of a grip cover 20 of the present invention is illustrated. The grip cover 20 made of plastic material is integrally formed of a predetermined shape. Moreover, the grip cover 20 can be made of dual plastic materials by injection molding, so that a gripping effect of a dual material can be provided therewith. The grip cover 20 comprises a top end and a slot 21 which is formed on the top end in an axial direction and provided for being inserted by the grip body 16 of the head part 10. An elastic body 22 formed as an elastic hollow circular ring is jacketed to the top end of the grip cover 20. The top end of the grip cover 20 has a first connecting portion 23 corresponding to the first stage portion 12 of the head part 10, a second connecting portion 24 corresponding to the second stage portion 13 of the head part 10, a third connecting portion 25 corresponding to the third stage portion 14 of the head part 10, and a fourth connecting portion 26 corresponding to the fourth stage portion 15 of the head part 10. In this embodiment, the first connecting portion 23 and the second connecting portion 24 of the grip cover 20 corresponding to the first stage portion 12 and the second stage portion 13 of the head part 10 are respectively formed of convex arc surfaces. Accordingly, the first stage portion 12, the second stage portion 13, the third stage portion 14 and the fourth stage portion 15 of the head part 10 are respectively correspondingly embedded to the first connecting portion 23, the second connecting portion 24, the third connecting portion 25 and the fourth connecting portion 26 of the grip cover 20, so that the head part 10 and the grip cover 20 are correspondingly embedded and combined to each other and the fitness therebetween can be increased by the elastic body 22.

In order to further understand the structural features, technical means, and expected functions and effects of the present invention, the detailed operational method of the present invention are described below.

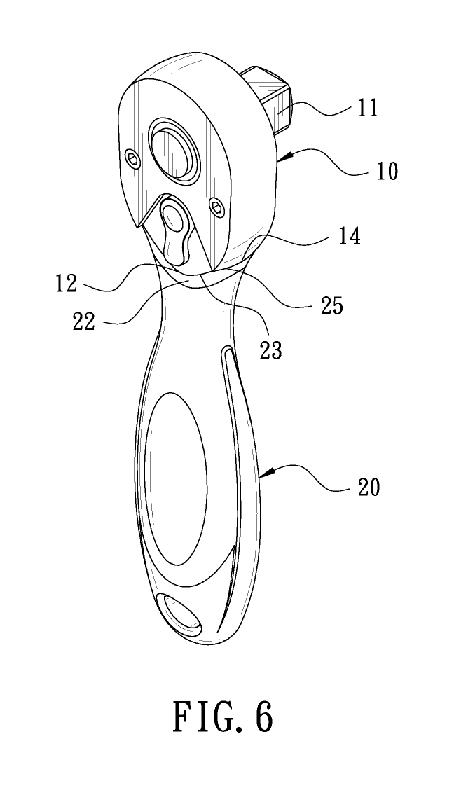

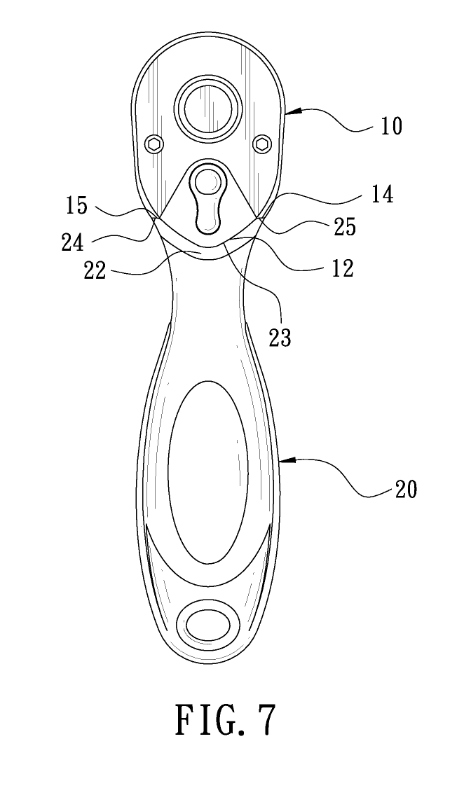

Referring to FIGS. 6 and 7, an assembled perspective view and a front view of the first preferred embodiment of the present invention are illustrated. Firstly, when the grip body 16 of the head part 10 is inserted in the slot 21 of the grip cover 20, the first stage portion 12, the second stage portion 13, the third stage portion 14 and the fourth stage portion 15 of the head part 10 are correspondingly respectively embedded to the first connecting portion 23, the second connecting portion 24, the third connecting portion 25 and the fourth connecting portion 26 of the grip cover 20, so that the head part 10 and the grip cover 20 are correspondingly embedded and combined to each other with increased fitness therebetween. Further, due to the grip cover 20 formed by injection molding in an independent mold, the molding speed and pressure and other conditions of the grip cover 20 can be easily controlled, thus to provide an optimistic yield of the grip cover 20. Moreover, with sets of independent molds, various types of the grip covers 20 can be formed in the molding process, capable of providing different type of ratchet wrenches to satisfy different clients' requirements and increasing the productivity competitiveness in the market.

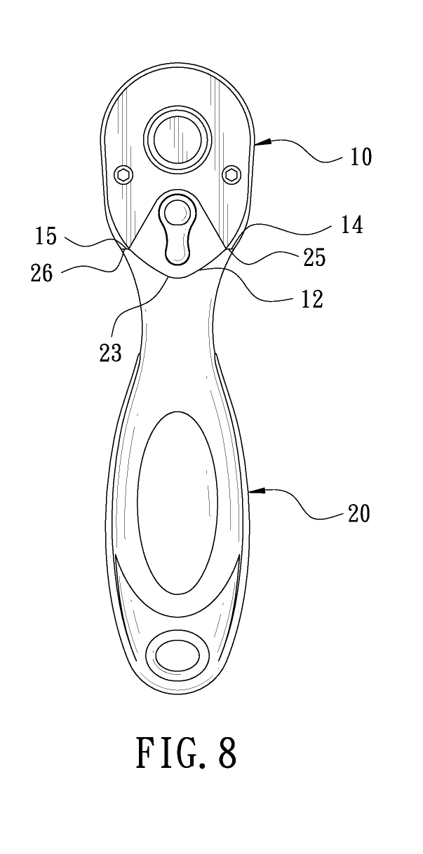

Referring to FIG. 8, a front view of a second preferred embodiment of the present invention is illustrated. The second preferred embodiment differs from the elastic body 22 is not provided between the first preferred embodiment in that the head part 10 and the grip cover 20, and the head part 10 and the grip cover 20 still can be embedded and combined to each other with a perfect fitness therebetween.

What is claimed is:

1. A combination structure of a head part and a grip cover of a ratchet wrench, comprising:
a head part, comprising a bottom end having a front side formed with a first stage portion, a rear side formed with a second stage portion, a left side formed with a third stage portion, a right side formed with a fourth stage portion, and a middle portion provided with a grip body; and
a grip cover, comprising a top end and a slot formed on the top end and inserted by the grip body of the head part, the top end of the grip cover having a first connecting portion corresponding to the first stage portion of the head part, a second connecting portion corresponding to the second stage portion of the head part, a third connecting portion corresponding to the third stage portion of the head part, and a fourth connecting portion corresponding to the fourth stage portion of the head part;
wherein the first stage portion, the second stage portion, the third stage portion and the fourth stage portion of the head part are correspondingly respectively embedded to the first connecting portion, the second connecting portion, the third connecting portion and the fourth connecting portion of the grip cover, so that the head part and the grip cover are correspondingly embedded and combined to each other with increased fitness therebetween.

2. The combination structure of the head part and the grip cover of the ratchet wrench as claimed in claim 1, wherein the grip cover made of plastic material is integrally formed of a predetermined shape.

3. The combination structure of the head part and the grip cover of the ratchet wrench as claimed in claim 1, wherein the first stage portion and the second stage portion of the head part are respectively formed of concave arc surfaces, and the first connecting portion and the second connecting portion of the grip cover corresponding to the first stage portion and the second stage portion of the head part are respectively formed of convex arc surfaces.

4. The combination structure of the head part and the grip cover of the ratchet wrench as claimed in claim 1 further comprising an elastic body jacketed to the top end of the grip cover and formed as an elastic hollow circular ring.

5. The combination structure of the head part and the grip cover of the ratchet wrench as claimed in claim 1, wherein the head part made of a preferred rigid and hard metal is integrally formed and enclosed by a light material selected from one of high molecular polymer, aluminum or magnesium alloy.
